(19) United States
(12) Patent Application Publication
(10) Pub. No.: US 2006/0116901 A1
(43) Pub. Date: Jun. 1, 2006

(54) Information providing method, recording medium, and server

(75) Inventors: Kazushi Ookubo, Kawasaki (JP); Shigemi Kamimoto, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 11/331,080

(22) Filed: Jan. 13, 2006

Related U.S. Application Data
(63) Continuation of application No. PCT/JP03/09041, filed on Jul. 16, 2003.

(51) Int. Cl. G06Q 99/00

(52) U.S. Cl. 705/1

(57) ABSTRACT

An information providing method comprises the step of detecting a predetermined operation on first information displayed on a client terminal, the step of detecting a predetermined operation on second information displayed on the client terminal, the step of generating comparative information by comparing the first and second information when the second information is judged to he in a predetermined relation with the first information, and the step of providing the comparative information to the client terminal.

### CROSS-REFERENCE TO RELATED APPLICATION

This is a continuation of Application PCT/JP2003/009041, filed on Jul. 16, 2003, now pending, the contents of which are herein wholly incorporated by reference.

### BACKGROUND OF THE INVENTION

The present invention relates to a technology for information providing such as advertising and promotion activities via a network such as the Internet.

Conventionally, a technology for conducting advertising and promotion activities via the Internet takes various forms such as a reverse auction, a web catalog, an on-line estimation, or a used car sales web site.

In a parts search of reverse auction type, a user inputs a desirable specification and the like to perform the search. However, the parts search of the reverse auction type is not convenient because the user must input many items.

In the web catalog, data of a comparison target is displayed by merely in a form of a text document to provide a part of information. Alternatively, the web catalog has a link established to the other detailed information. In the on-line estimation, only a mere total amount is calculated and displayed.

In a comparison displaying function generally used in the used car sales web in many cases, the text document is only laid from side to side to be displayed. Even if a link is established to a different web site, the link is independently installed. For example, according to the comparison displaying function, as shown in FIG. 20, a content A provided by a server A and a content B provided by a server B are laid side-by-side to be displayed on a screen of a user terminal. At this time, a link from the content A is installed on the server A, independently of a link from the content B installed on the server B.

Further, there has been provided a system for preparing an optimal travel guide plan according to travel request conditions designated by a user through a terminal in the user's home and instantly provide the plan to the user, without requiring the user to visit a travel agency (refer to Patent Document 1).

Patent Document 1

JP 2002-73756 A (Abstract)

### SUMMARY OF THE INVENTION

However, the conventional technology has the following problems. In the products search of the reverse auction type, the user inputs the items such as the desirable specification and the like to perform the products search. Thus, a difference of a specification or the like between different products and the information related to the difference must be acquired one by one by the user himself/herself separately even if the products belong to the same item.

For example, the user individually acquires the information regarding the auxiliaries for compensating for the difference between the specifications and the product that can be charged on the balance. In this case, the information to be acquired varies from one user to the other, depending on the level of skill in the Internet search and the degree of interest with regard to the information to be acquired.

Also, there is a case where a person conducting advertising activities cannot sufficiently reserve the chance to advertise the feature of the product and the like to the user. Also, there is a case where the user cannot recognize the specification and the price by considering a quotation.

Thus, for both of the user and the advertisement provider, a mechanism for the conducting advertising and promotion activities through the Internet is not appropriate enough.

The present invention has been made in view of the problems in the conventional technology. It is therefore an object of the present invention to provide a technology that enables a user to easily obtain the information generated through the comparison between products and the information related to a difference of the products, and enables an advertisement provider to efficiently advertise products to the user.

In order to solve the above-described problems, the present invention adopts following measures. That is, an information providing method according to the present invention is characterized by including the steps of: detecting a predetermined operation on a first information displayed on a communication apparatus (client terminal); detecting a predetermined operation on a second information displayed on the communication apparatus (client terminal); generating comparative information by comparing the first information with the second information; and providing the comparative information to the communication apparatus (client terminal).

In the information providing method, when the second information is judged to be in a predetermined relation with the first information, the first information and second information may be compared with each other in the step of generating the comparative information.

For example, when the first information and second information indicate prices or performances related to products, the comparative information indicates a difference between the prices or the performances of the products.

The execution of the steps enables the user, who uses the present invention, to easily obtain the information generated by comparing the prices or performances of the products. In addition, the person who advertises the product can efficiently advertise the product. As a result, the user can judge the product more efficiently from a multilateral point of view.

Also, in this case, the information providing method according to the present invention may further include executing the steps of: generating a related product information corresponding to the difference between the prices or the performances; and providing the related product information to the communication apparatus (client terminal).

The execution of the steps enables the user, who uses the present invention, to easily obtain the information related to the difference between the products.

Also, the predetermined operation may be a clicking operation through a pointing device with respect to the first information or the second information. In this case, the user who uses the present invention repeats the clicking operation through the pointing device to successively obtain the comparative information.

Also, the predetermined operation may include an input of the input information including the first information and the second information, and a transmission request of the input information. In this case, there is no need to judge whether or not the second information has the predetermined relation with the first information. Thus, a processing time can be shortened.

Also, according to the present invention, a computer, other apparatuses (e.g. information providing apparatus), a machine, and the like may execute any of the processes. Also, the present invention may be a program for causing the computer, the other apparatuses, the machine, and the like to attain any of the functions. Also, according to the present invention the above-mentioned program may be recorded in a computer-readable recording medium and the like.

### BRIEF DESCRIPTION OF THE DRAWINGS

FIG. 1 is a system configuration view;

FIG. 2 shows a transmission algorithm of input information;

FIG. 3 shows a user terminal screen (content representation);

FIG. 4 shows a user terminal screen (target product selection);

FIG. 5 shows a user terminal screen (difference window);

FIG. 6 shows a user terminal screen (link information);

FIGS. 7A-7B show a data table;

FIG. 8 shows an input information;

FIG. 9 shows a process flow between a user terminal and a management server;

FIG. 10 shows a process flow of a difference window data preparation;

FIG. 11 shows a process flow of a data search in a difference amount vicinity;

FIGS. 12A-12B show a data setting screen;

FIG. 13 shows the user terminal screen (in a case of a hand input);

FIG. 14 shows the input information (in the case of the manual input);

FIG. 15 shows a process flow between the user terminal and the management server (in the case of the manual input);

FIG. 16 shows a process flow of the difference window data preparation (in the case of the manual input);

FIG. 17 shows a process flow of the data search in the difference amount vicinity (in the case of the manual input);

FIG. 18 is a view to explain an input information transmission route according to a modified example;

FIG. 19 shows a transmission algorithm of input information according to a modified example; and

FIG. 20 is a conventional system configuration example.

### DETAILED DESCRIPTION OF THE PREFERRED EMBODIMENT

### Preferred Embodiment Mode

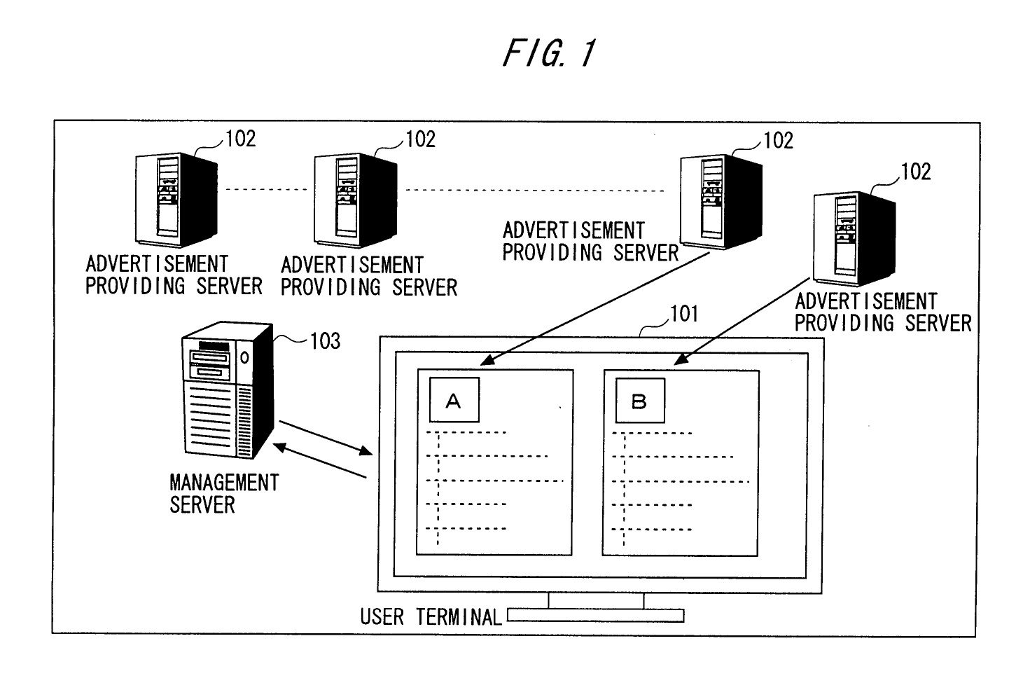

This embodiment is explained by applying the present invention to a web site that sells a personal computer related product, and by referring to the drawings from FIGS. 1 to 12.

That is, in this embodiment, a user is instructed to select prices, specifications, and the like of at least two products on the content provided by the web site. The selected prices and specifications of the products are compared, and a difference obtained by the comparison and information related to the difference are provided. Hereafter, the first selected product is referred to as a standard product, and the next selected product is referred to as a target product.

<System Configuration>

With reference to FIG. 1, a system configuration is explained. This system includes a user terminal 101, a plurality of advertisement providing servers 102, and a management server 103, which are connected through a network such as the Internet.

The user terminal 101 is a multi-purpose computer having a communication apparatus where the user can read the content. The user terminal 101 displays the content, which is provided through the network by an advertisement provider, on the screen. Then, the user selects the prices and specifications of the products within the content.

The user terminal 101 transmits the information (hereafter, input information) with regard to the product selected by the user to the management server 103. The input information includes, information to identify which of the standard product or the target product the input information relates to, and information required to compare the products.

Also, the user terminal 101 receives the difference obtained by the comparison from the management server 103 and the information related to the difference, and displays the difference and the information on the screen.

The plurality of advertisement providing servers 102 are the servers where a person providing an advertisement and a promotion delivers the content to a typical user. This server 102 may directly deliver the content to the user terminal 101, or install a web server (not shown) on the network and deliver the content through the web server to the user terminal 101.

The management server 103 receives the input information transmitted from the user terminal 101, executes a predetermined processing, and transmits the difference obtained by the comparison and the information related to the difference to the user terminal 101. As the predetermined processing executed by the management server 103, there are a difference calculation and a data search in a difference amount vicinity.

<Input Information Transmission Route>

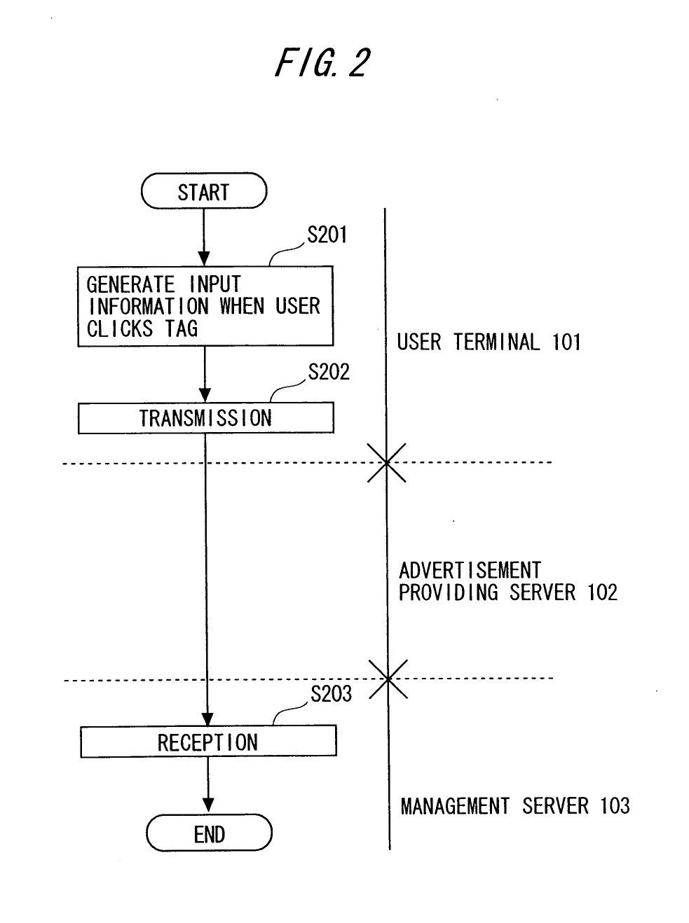

By referring to FIG. 2, a transmission algorithm of the input information transmitted by the user terminal 101 is explained.

In this embodiment, the user clicks a representation defined by a tag related to a link destination address within the content (hereafter, this representation is merely referred to as a tag) to select the price and specification of the product.

Here, the tag is a string for defining a format attribute indicating the feature of a web page, such as content, and its element. Then, the tag is used to execute various predetermined functions. For example, in a case where the link destination address of a different web site is contained in the tag, the user terminal 101 displays the content provided by the web site at the link destination address when the representation defined by the tag is clicked. Hereafter, the input method is referred to as a click input.

The user terminal 101, when the user clicks the tag within the content, generates the input information (S201). This input information can be generated by using a programming language such as JAVA (Registered Trademark). Then, the user terminal 101 directly transmits the generated input information to the management server 103 (S202).

On the other hand, the management server 103 receives the input information generated by the user terminal 101, through the network (S203).

<Screen Shift Example>

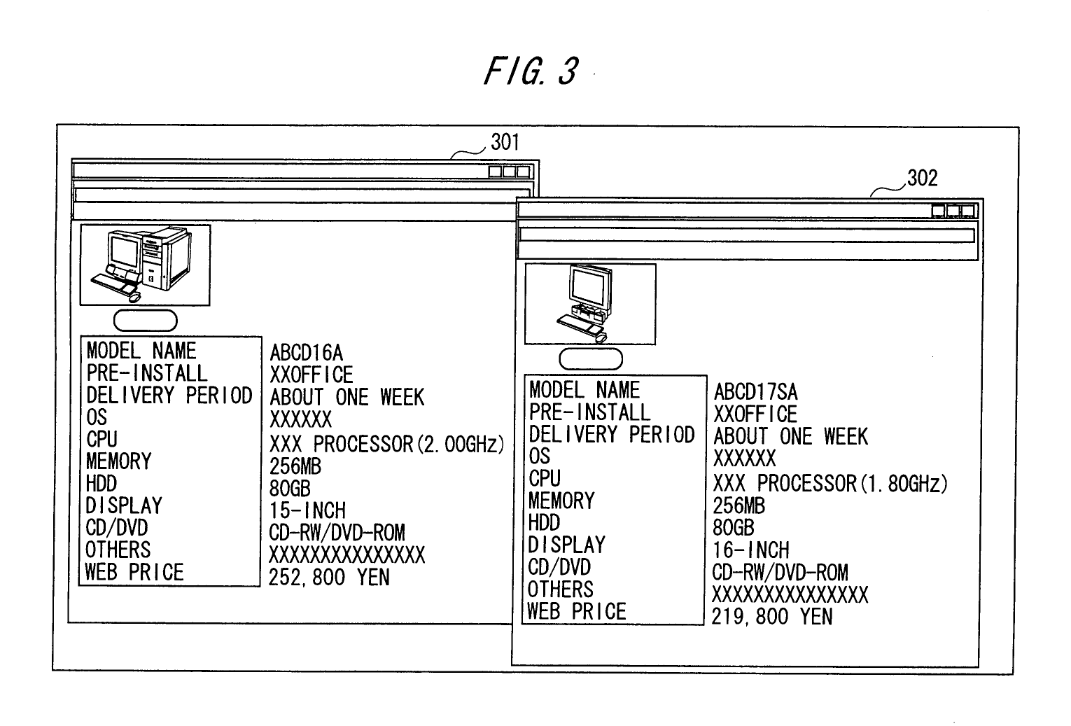

By referring to FIGS. 3 to 6, a shift example of the user terminal screen is explained. FIG. 3 shows the user terminal screen when the content is displayed.

Contents 301 and 302 provided by the advertisement providing server 102 include product information such as the specifications and prices of the products. Those contents 301 and 302 are displayed through the Internet and the like on the user terminal 101. This embodiment indicates the contents 301 and 302 about a personal computer of a desk top type.

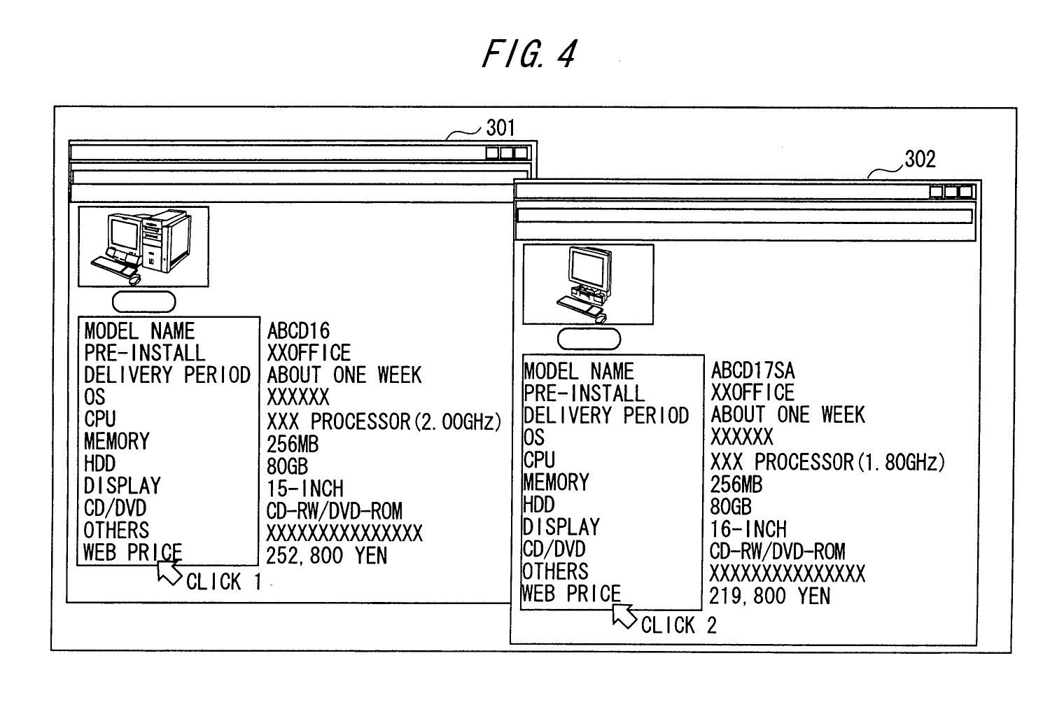

FIG. 4 shows the user terminal screen when the user selects two products to be compared. The user selects the standard product serving as the standard of the comparison and the target product serving as the target of the comparison through the user terminal 101.

In this embodiment, as the selecting method of the tag, the user puts a cursor on the representation defined by the tag and clicks a mouse or the like. At this time, an action of a first click on the tag by the user is referred to as a click 1, and an action of a next click on the tag by the user is referred to as a click 2.

When the tag is clicked, the user terminal 101 generates the input information with regard to the product and transmits the information to the management server 103. The method of generating the input information upon clicking the tag uses the programming language such as JAVA (Registered Trademark).

This embodiment indicates an example that the user selects a main body price. However, the information with regard to the product selected by the user is not limited to the price, and it may be the information with regard to the specification of the product.

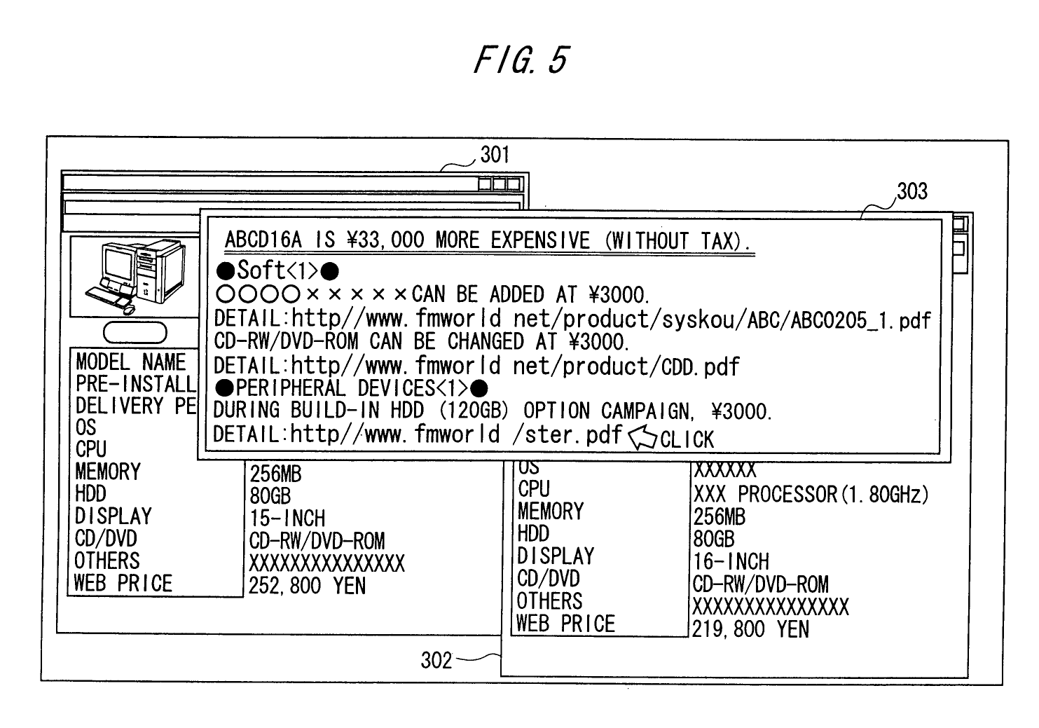

FIG. 5 shows a difference window. The difference window 303 displays the difference obtained by the comparison and the information related to the difference. In this embodiment, the difference obtained by the comparison is represented as “Model Name ABCD16A is ¥3,300 more expensive”, and the information related to the difference is represented as “software” and “peripheral device”.

Those “software” and “peripheral device” are the products that can be bought for 3,300 yen, which is the balance. Also, the difference window 303 simultaneously displays URL to the web site including the detailed information on the software and peripheral devices. Hereafter, the detailed information delivered by the web site is referred to as link information.

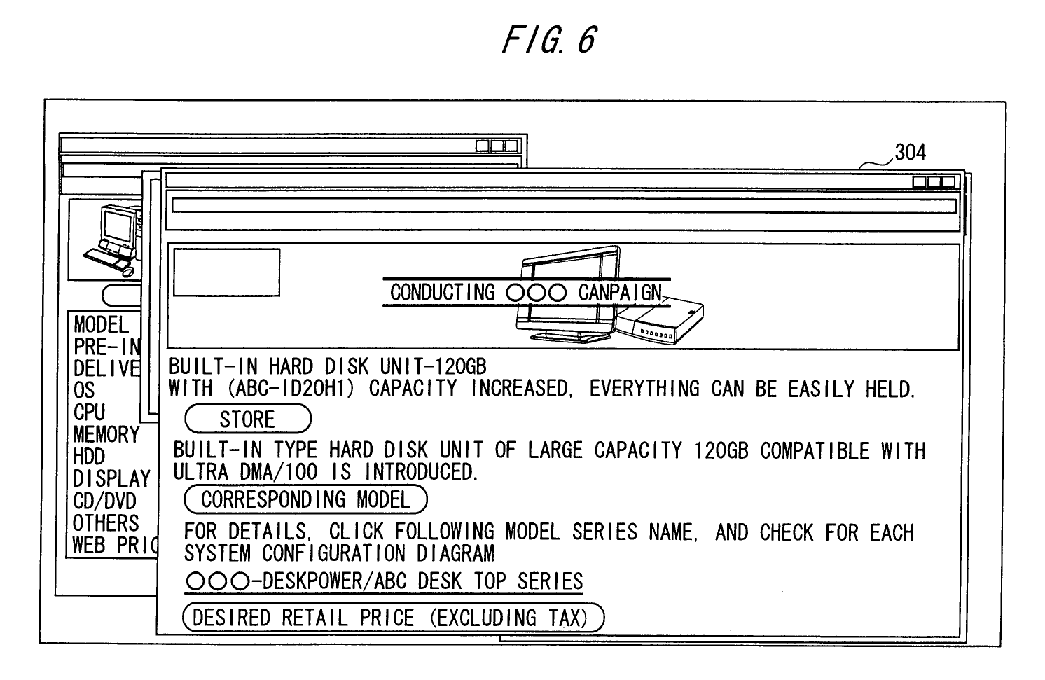

FIG. 6 shows the link information with regard to the product. The link information 304 is the detailed information with regard to the product displayed on the difference window 303, and is acquired from the web site and displayed. As this detailed information, there is an overview of the product, a corresponding model, the price, or the like.

<Table Structure>

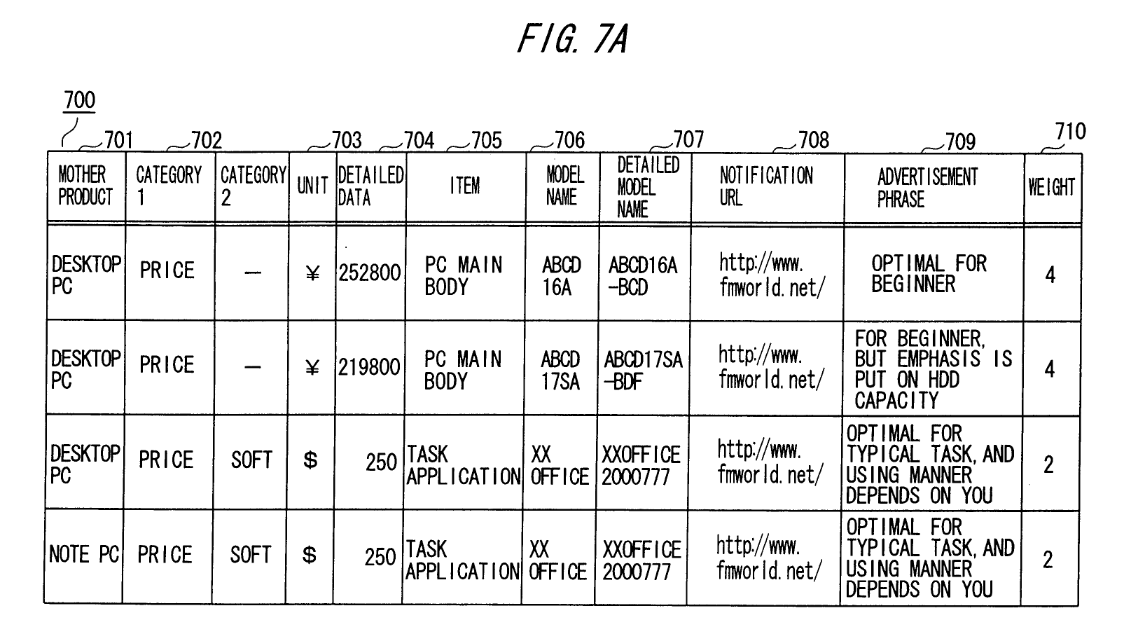

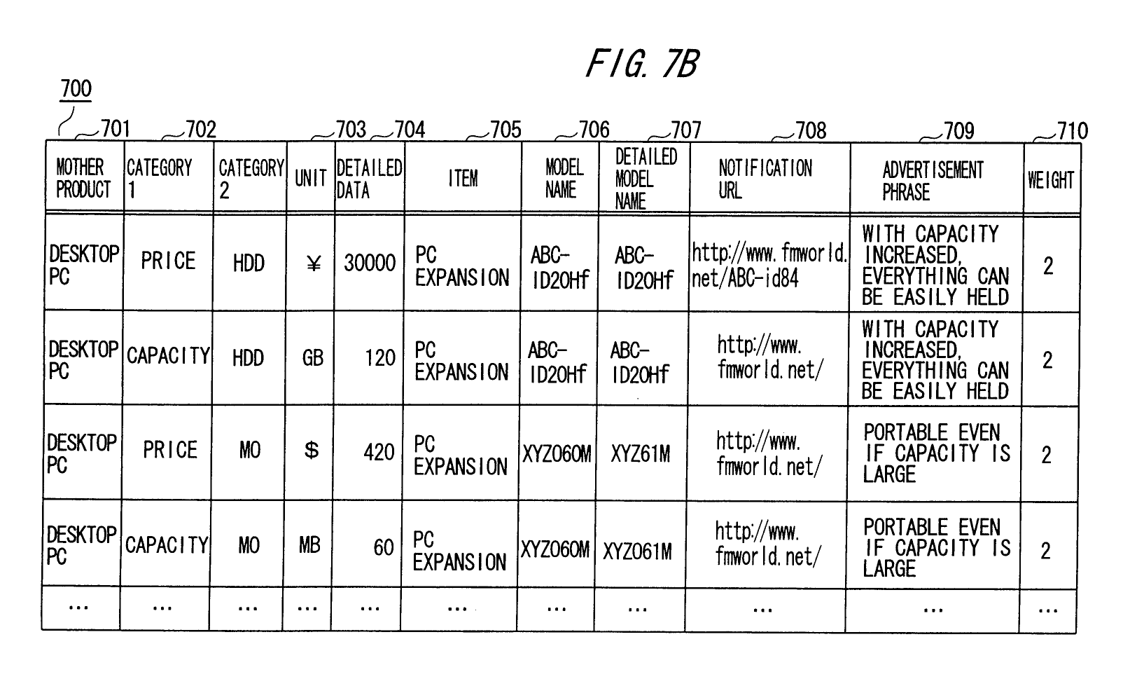

FIG. 7A-7B show a data table 700 held by the management server 103. The data table 700 stores product data contained in the content provided by the web site of each company.

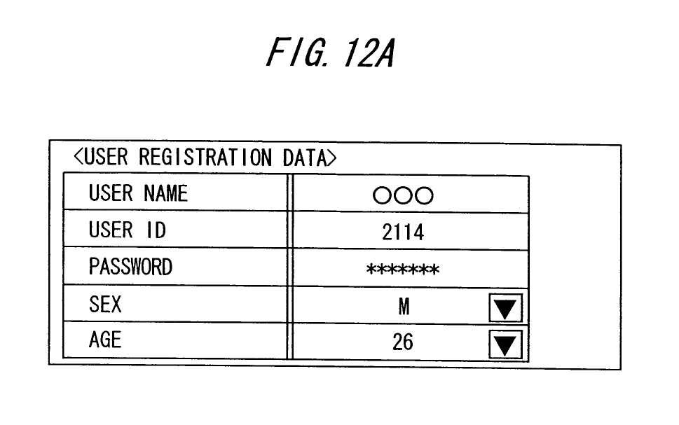

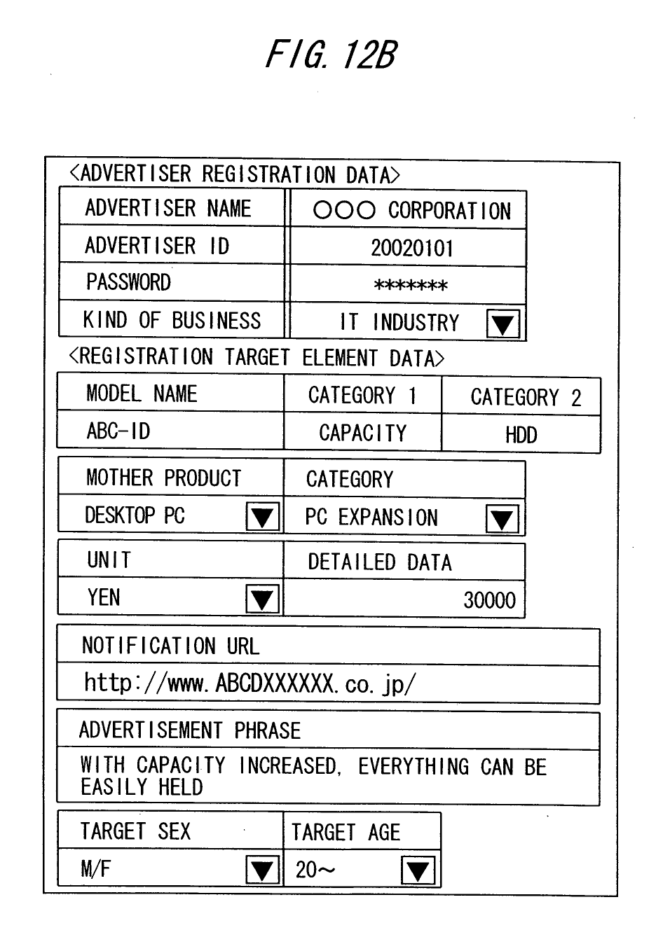

The product data is registration target element data registered on a registration data setting screen shown in FIG. 12B. The registration target element data is registered in the management server 103 when an advertisement provider is registered. The registration target element data will be explained later together with the registration of the advertisement provider.

Also, the product data includes fields of a mother product 701, a category 702, a unit 703, detailed data 704, an item 705, a model name 706, a detailed model name 707, a notification URL 708, an advertisement phrase 709, a weight 710, and the like.

The mother product 701 stores a name of a mother product. Here, when an application (“Task Application” is described in the item 705) indicated as a model name “XXOFFICE” is exemplified, the application is used as DESKTOP PC or NOTE PC. Thus, a record storing the DESKTOP PC and a record storing the NOTE PC exist in the field of the mother product 701.

The category 702 stores information to identify the detailed data 704. For example, with regard to a product of a model name “ABC-ID20H1” that is an HDD (hard disk drive), there is data about a price and memory capacity. In this case, there are the record storing the price in the category 1 and the HDD in the category 2, and the record storing the memory capacity in the category 1 and the HDD in the category 2.

The unit 703 stores the unit of the detailed data 704. For example, the unit of the detailed data 704 is “¥”, if the category 1 is the price, and is “GB” if the category 1 is the HDD capacity.

The detailed data 704 stores the numeral, such as the price, or the capacity, correspondingly to the category. The item 705 stores the item of the product, and the model name 706 stores the model name of the product.

The notification URL 708 stores the URL of the content where each product is shown. The URL is the URL to the web site that provides the detailed information of the product, which is included in the information related to the difference of the product.

Then, the advertisement phrase 709 stores the advertisement phrase of the product, namely, the catch phrase of the product.

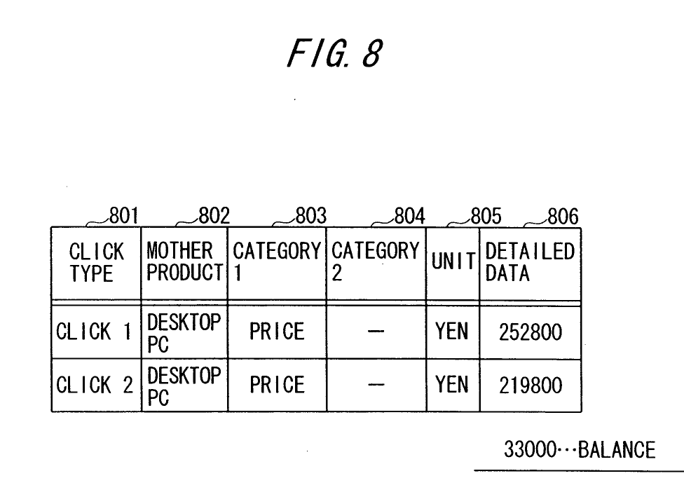

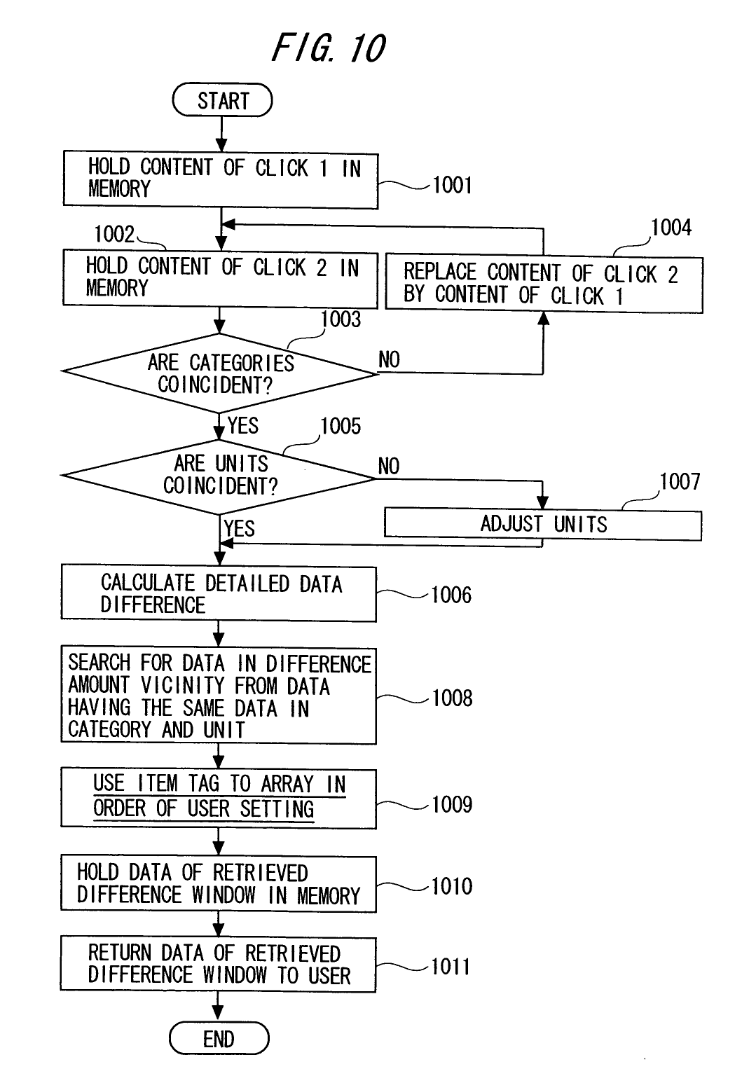

FIG. 8 shows input information transmitted to the management server 103 from the user terminal 101. The input information is generated by the user terminal 101 upon clicking on the tag in the content by the user, and transmitted to the management server 103. Also, the management server 103 refers the input information when the difference of the detailed data is calculated in a data preparing process for a difference window shown in FIG. 10.

The input information includes a click type 801, a mother product 802, a category 803, a unit 804, and detailed data 805.

The click type 801 stores information to identify whether the input information is a click 1 or a click 2. Here, the click 1 is the input information first clicked by the user, and the click 2 is the input information next clicked by the user. In short, the click 1 corresponds to the input information with regard to the product serving as the standard of comparison, and the click 2 corresponds to the input information with regard to the product serving as the target of comparison.

The definitions of the mother product 802, the category 803, the unit 804, and the detailed data 805 are similar to those of the mother product 701, the category 702, the unit 703, and the detailed data 704 shown in FIG. 7.

<Process Flow>

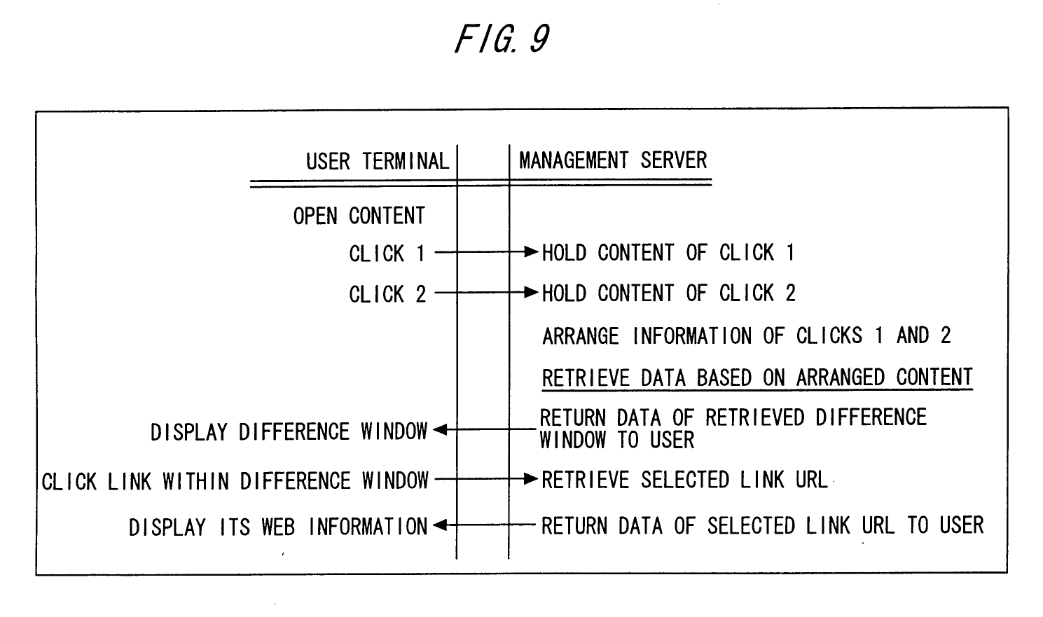

With reference to FIG. 9, the flow of the process between the user terminal 101 and the management server 103 is explained.

The user terminal 101 displays the content delivered by the advertisement providing server 102, as shown in FIG. 3.

Then, as shown in FIG. 4, the user puts the cursor on the representation which is defined by the tag related to the link destination address within the content, and clicks the mouse or the like. At this time, an action of a first click on the tag by the user is referred to as a click 1, and an action of a next click on the tag by the user is referred to as a click 2.

The user terminal 101 recognizes that the click 1 or click 2 is executed by the user, and transmits the content of the click 1 or click 2 to the management server 103.

The management server 103 receives the content of the click 1 or click 2 transmitted from the user terminal 101 and hold the content.

Here, the content of the click 1 or click 2 is the input information transmitted to the management server 103 by the user terminal 101 through execution of the click 1 or click 2 by the user.

The management server 103 arranges the contents of the clicks 1 and 2, and searches for the data in accordance with this arranged contents. Here, the arrangement of the contents means that the input information items are compared and the difference is calculated. Also, the data search means a search for the data in the difference amount vicinity.

Then, the management server 103 converts the data of the calculated difference and the retrieved data in the difference amount vicinity into the data indicated in the difference window 303 shown in FIG. 5, and transmits the data to the user terminal 101. Hereafter, this data is also referred to as a difference window data.

Then, the user terminal 101 receives the data and displays the difference window 303 shown in FIG. 5 on the screen.

Then, the user terminal 101, when recognizing that the user clicks the tag inside the difference window 303, requests the management server 103 to retrieve the URL of the selected link destination.

Then, the management server 103 refers to the data table 700 shown in FIG. 7 and retrieves the URL of the link destination. Then, the management server 103 transmits the data of the detected link destination URL to the user terminal 101.

The user terminal 101 obtains the web information of the link destination from the data of the received URL.

The process when the management server 103 generates the difference window data will be explained below with reference to FIG. 10.

The management server 103 receives the input information when the user executes the click 1, and holds the content of the click 1 in a memory (S1001). Here, the management server 103 stores, in a database, the input information which is transmitted from the user terminal 101 and in which the click type 801 is the click 1, as the product data serving as the standard of the comparison.

Then, the management server 103 receives the input information when the user executes the click 2, and holds the content of the click 2 in the memory (S1002). Here, the management server 103 stores, in the database, the input information which is transmitted from the user terminal 101 and in which the click type 801 is the click 2, as the product data serving as the target of the comparison.

Then, in S1003, the management server 103 judges whether or not the categories of the two input information items are coincident (S1003). In short, the input information in which the click type 801 is the click 1, and the input information in which the click type 801 is the click 2 are compared with each other to judge whether or not the categories 803 are coincident.

The management server 103, if it is judged that the categories 803 are not coincident, replaces the content of the click 2 with the content of the click 1 (S1004). Then, the processing returns to the S1000 and, the management server 103 holds the content of the click 1 in the memory. That is, if the category 803 of the input information of the click 1 and the category 803 of the input information of the click 2 are not coincident, the management server 103 overwrites and stores the content of the click 2 as the content of the click 1. Then, the management server 103 waits for reception of the content of the click 2 that is a next click.

With the above processes, the management server 103 repeats the processes from the S1001 to the S1004 until the categories 803 matches in the input information of continuous two clicks. However, if the categories 803 are not coincident, the management server 103 may not replace the content of the click 2 with the content of the click 1 nor hold the content in the memory, and may discard the content. In this case, in the process of the S1004, the management server 103 discards the content of the click 2.

On the other hand, in the S1003, if it is judged that the categories 803 are coincident, the management server 103 judges whether or not the units 804 of the input information are coincident (S1005).

At the S1005, the management server 103, if judging that the units 804 of the input information are coincident, calculates the difference between the detailed data 805 (S1006).

On the other hand, in the S1005, the management server 103, if judging that the units 804 of the input information are not coincident, adjusts the units 804 (S1007). In short, the unit of the input information serving as the comparison target is converted into the unit of the input information serving as the comparison standard. For example, if the unit of money is used as the unit 804, an exchange rate that is a conversion rate of money is used. The exchange rate may be obtained from the dedicated web site or may be periodically updated by an administrator of the management server 103.

Then, the management server 103 calculates the difference of the detailed data 805 (S1006).

Next, the management server 103 search for the data in the difference amount vicinity in which the categories 803 and the units 804 are the same data in the same mother product 802 (S1008). For example, if the unit of money is used, the management server 103 retrieves the product data which can be bought for the balance and can belong to the mother product, as the data in the difference amount vicinity.

The management server 103 uses an item tag and arranges in the order of user setting (S1009). In short, the management server 103 rearranges the retrieved product data in accordance with the user setting.

The management server 103 holds the data of the difference window 303 in the memory (S1010) The data of the difference window 303 is the data to display the difference obtained by the comparison and the information related to the difference on the user terminal 101.

The management server 103 returns the data of the difference window 303 back to the user and ends the processes (S1011).

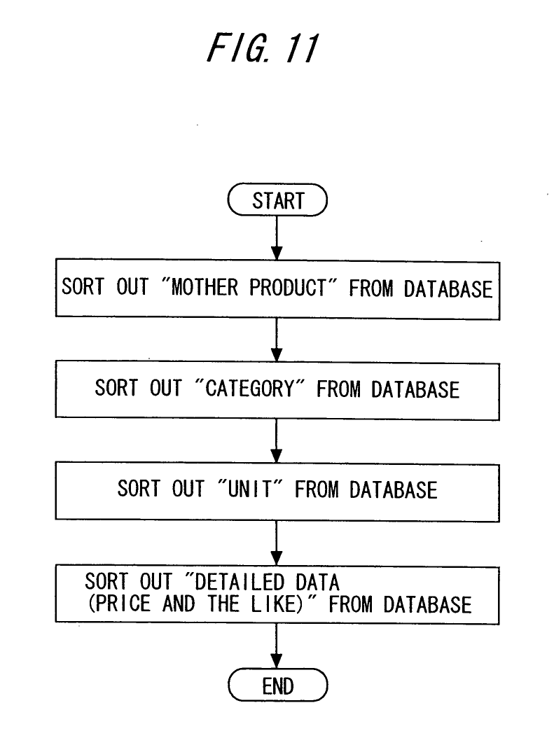

The S1008 of FIG. 10 will be explained below in detail with reference to FIG. 11. FIG. 11 shows the process flow of the data search in the difference amount vicinity.

First, the management server 103 sorts out the mother product 802 from the database (S1101). Hereafter, the database points out the data table 700 on the database shown in FIG. 7. Here, the management server 103 retrieves the products of the same mother product 802 from the data table 700.

Then, the management server 103 sorts out the category 803 from the database (S1102). Here, the management server 103 further retrieves the products of the same category 803.

Then, the management server 103 sorts out the unit 804 from the database (S1103). Here, the management server 103 further retrieves the products of the same unit 804.

Then, the management server 103 sorts out the detailed data 805 from the database (S1104). Here, the management server 103 further retrieves products in accordance with the detailed data 805. For example, if the unit of money is used as the unit 804, the management server 103 retrieves the product data, which can be bought for the balance calculated in the S1006, as the data in the difference amount vicinity. By the way, there is a case that the product is not detected at this time.

In this embodiment, the management server 103 regards the mother product 802, the category 803, the unit 804, and the detailed data 805 as the sorting condition, to retrieve the product. However, the sorting condition may be set by the user.

<Registration Data Setting Screen>

With reference to FIG. 12, the setting of the registration data is explained. FIG. 12(A) shows the registration data setting screen of the user. The user means a person who accesses an advertisement providing server through the user terminal 101 and to which the information is provided. Then, FIG. 12(B) shows the registration data setting screen of an advertisement provider. The advertisement provider means a person who provides the advertising and promotion activities of the product and the like to the user.

As the registration data of the user, there are a user name, a user ID, a password, a sex distinction, an age, and the like. The user terminal 101 recognizes a data input from the user and transmits the input data to the management server 103.

The management server 103 search the registered data for the user ID and the user password to see whether or not they are already registered, in order to avoid the duplex registration. Then, the management server 103, if it is judged that the user ID and the user password are not registered, registers this user. On the other hand, the management server 103, if judging that the user ID and the user password are already registered, reports the fact that the user ID and the user password are improper, to the user terminal 101.

The registration data at the time of the registration by the advertisement provider will be explained below. As the registration data of the advertisement provider, there are advertiser registration data, registration target element data, and the like.

The advertiser registration data includes information to identify a person providing the advertising activities, such as an advertiser name, an advertiser ID, and a password. Moreover, the advertisement registration data may include information for the management server 103 to classify the advertisement provider, such as a business type.

The advertisement providing server 102 transmits the advertiser ID and the password which are inputted by the advertisement provider, to the management server 103. The management server 103 search the registered data for the advertiser ID and the password to see whether or not they are already registered, in order to avoid the duplex registration. Then, the management server 103, if it is judged that the advertiser ID and the password are not registered, registers this advertisement provider. On the other hand, the management server 103, if judging that the advertiser ID and the advertiser password are already registered, reports the fact that the advertiser ID and the advertiser password are improper, to the advertisement providing server 102.

That is, the advertisement provider can register the product data as the registration target element data through the advertisement providing server 102 in the management server 103. Also, even after the registration of the advertisement provider, the advertisement provider can add or change the product data by adding or changing a registration target element and transmitting the element to the management server 103.

The registration target element data includes information to compare products, such as the model name, the mother product, the category, and the detailed data, and their units. Moreover, the registration target element data may include the information to provide the information such as the notification URL, and the advertisement phrase.

The registration data is stored in the database on the management server 103 as the data table 700 shown in FIG. 7.

### Effect of Embodiment Mode

According to this embodiment, the user can easily obtain the comparative information of the product and the information related to the difference. Then, the user can judge the difference more efficiently from a multilateral point of view. That is, the user can carry out a valuable purchase. Also, the person selling the products can efficiently perform the advertising activities on the user desiring to get the information.

Also, competitors can mutually advertise products by registering the product data in the management server. Thus, the person selling the products can reduce each advertisement cost.

Also, in this embodiment, the user clicks the representation defined by the tag two times to compare data on the products. However, the user may click the representation defined by the tag two times or more. In this case, the product data related to the representation clicked at the first time is used as the comparison standard, the product data related to the representation clicked at the second time is used as the comparison target, and the product data on the comparison standard and product data on the comparison target are compared with each other. Then, the product data related to the representation clicked at the third time is used as the comparison target and compared with the product data related to the representation clicked at the first time. Hereafter, each time the representation defined by the tag is clicked in this way, the clicked product may be repeatedly compared with the product data related to the representation clicked at the first time.

In this case, when the user clicks the prices of different products in turn, the balances between them are automatically calculated and displayed. Thus, the advertisement provider can introduce the optional product of a kind which is desired by the user and can be bought for the balance, to the user. On the other hand, the user can recognize the optional product and the like.

### MODIFIED EXAMPLE

In this embodiment, when the user clicks the representation defined by the tag on the screen, the input information is transmitted from the user terminal 101 to the management server 103. However, in this modified example, an input information screen is displayed on the user terminal 101, and the product serving as the comparison standard and the product serving as the comparison target are inputted by the user and transmitted to the management server 103. Hereafter, this input method is referred to as a manual input.

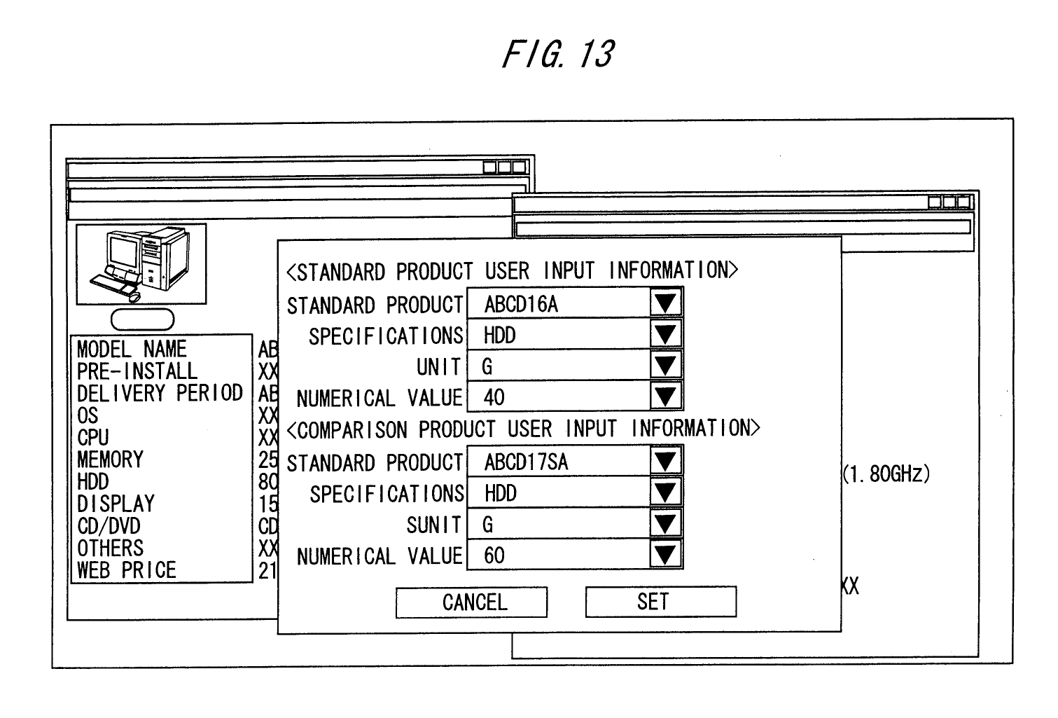

The modified example of the present invention will be explained below with reference to FIGS. 13 to 17.

<Input Information Screen>

FIG. 13 is a view when the user selects a product to be compared, by the manual input. Here, the user terminal 101 displays the input information screen 305 for inputting a standard product serving as a standard of the comparison and a target product serving as a target of the comparison and prompt the user to input the input information.

The user operates the user terminal 101 to input data of the comparison standard product and data of the comparison target product to the input information screen 305. Here, the input information may be directly inputted by the user, or may be selected from pre-registered data by the user. The user, when completing the input, clicks a determination button and transmits the input information to the management server 103.

<Table Structure>

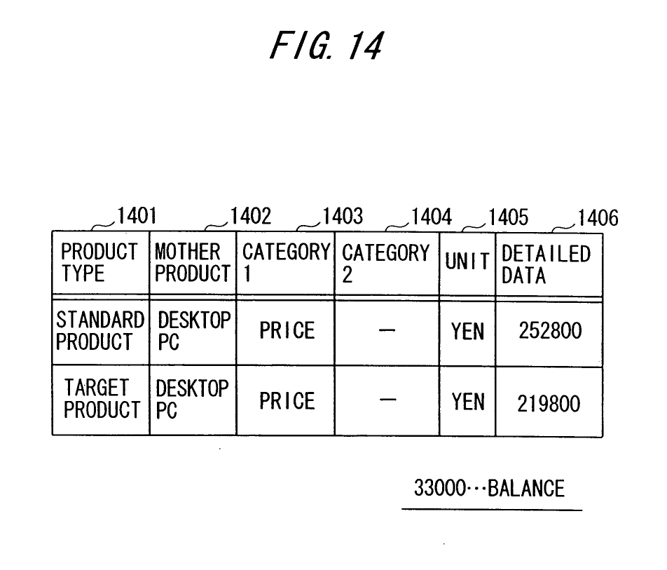

FIG. 14 shows data transmitted to the management server 103 from the user terminal 101. This input information differs from the input information shown in FIG. 8 in that a product type 1401 is included instead of the click type 801.

The other information are a mother product 1402, a category 1403, a unit 1404, and detailed data 1405.

The definitions of the mother product 1402, the category 1403, the unit 1404, and the detailed data 1405 are similar to those of the mother product 701, the category 702, the unit 703, and the detailed data 704 shown in FIG. 7.

<Process Flow>

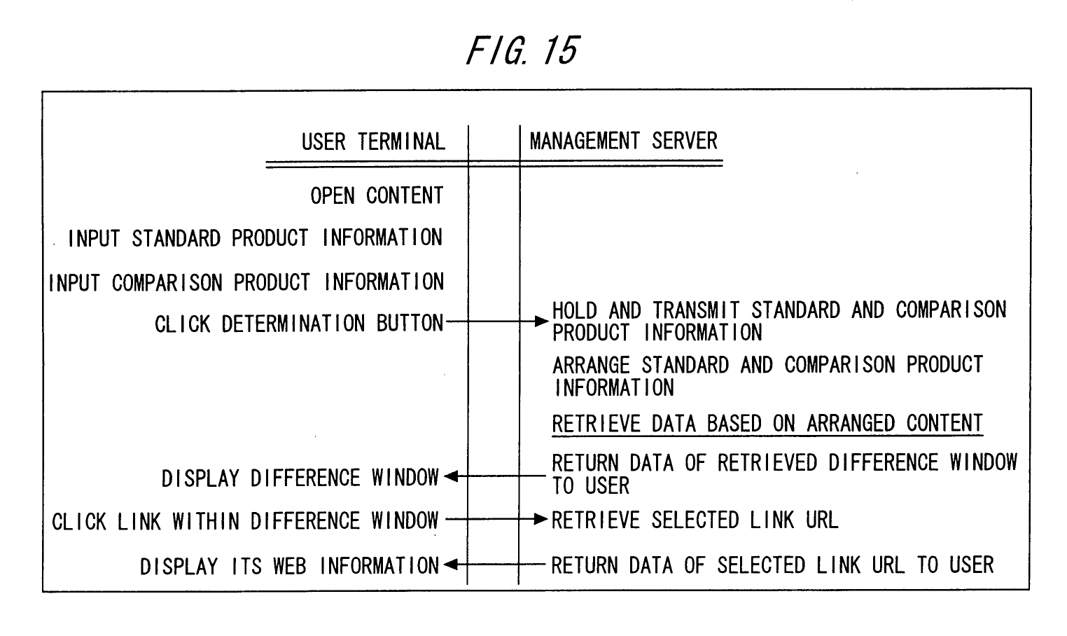

With reference to FIG. 15, the flow of the processes performed by manual input between the user terminal 101 and the management server 103 will be explained.

The user terminal 101 opens the content, which is provided to the management server 103 through the network by the advertisement provider, as shown in FIG. 3. In short, in accordance with the operation of the user, the user terminal 101 displays the content on the screen.

Then, the user inputs the input information of the standard product and the input information of the target product to the input information screen 305 shown in FIG. 13.

The user clicks the determination button after the completion of the input. When the user clicks the determination button, the user terminal 101 transmits the input information to the management server 103.

The management server 103 stores the product data of the standard product and the product data of the target product as the input information. The management server 103 arranges the received input information, and retrieves data in accordance with the arranged content. Here, the arrangement of information implies that comparison is performed on the input information to calculate the difference. Also, the data search implies the search for the data in difference amount vicinity.

Then, the management server 103 transmits the data of the calculated difference and the retrieved data in the difference amount vicinity, as the data of the difference window 303 shown in FIG. 5 to the user terminal 101.

Then, the user terminal 101 receives the data, and displays the difference window 303 shown in FIG. 5 on the screen.

Then, the user terminal 101, when recognizing that the user clicks the tag within the difference window 303, requests the search for the selected link destination URL.

Then, the management server 103 refers to the data table 700 shown in FIG. 7, and retrieves the URL of the link destination. Then, the management server 103 transmits the data of the detected link destination URL to the user terminal 101.

The user terminal 101 acquires web information of the link destination from the data of the received URL.

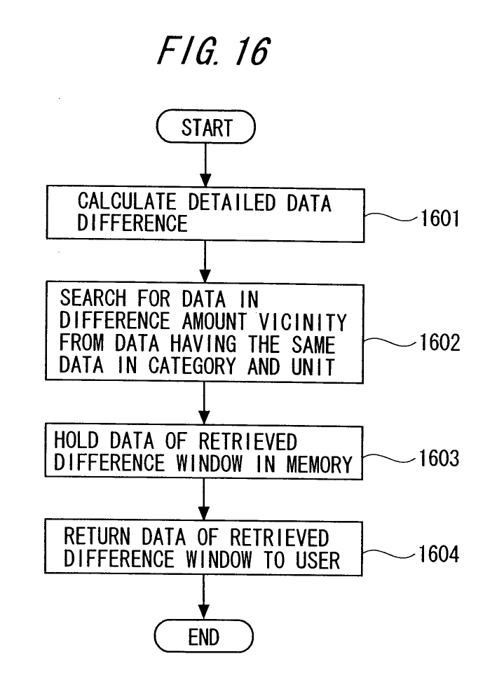

With reference to FIG. 16, the process for generating the difference window data in the management server 103 will be explained below. In this modified example, unlike the embodiment shown in FIG. 10, it is not necessary to judge whether or not the category 1403 and the unit 1404 of the input information are coincident.

First, the management server 103 calculates the difference of the detailed data 1405 (S1601).

Next, the management server 103 searches for the data in the difference amount vicinity from data having the same information in the mother product 1402, the category 1403, and the unit 1404 (S1602).

Then, the management server 103 holds the data of the difference window 303 in the memory (S1603). The data of the difference window 303 is used to display the difference obtained by the comparison and the information related to the difference on the user terminal 101.

The management server 103 returns the data of the difference window 303 to the user and ends the process (S1604).

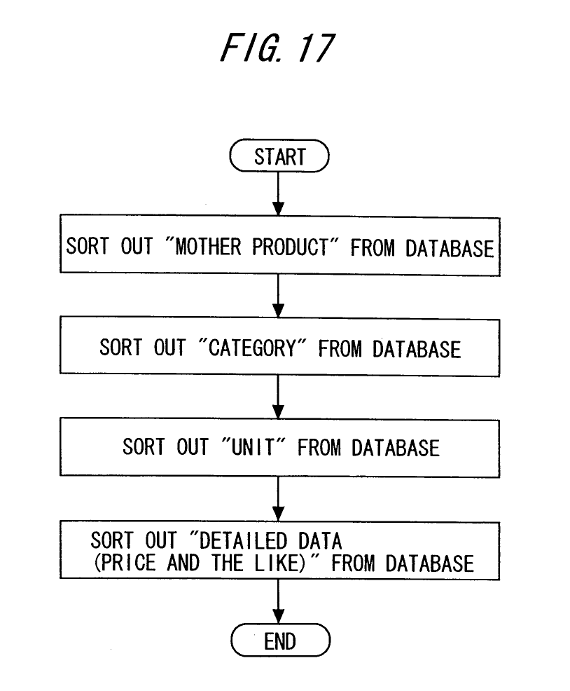

The process in S1602 of FIG. 16 will be explained below in detail with reference to FIG. 17. FIG. 17 shows a process flow of the data search in the difference amount vicinity.

First, the management server 103 sorts out the mother product from the database (S1701). Hereafter, the database indicates the data table 700 on the database shown in FIG. 7. Here, the management server 103 retrieves products having the same mother product from the data table 700.

Then, the management server 103 sorts out the category 1403 from the database (S1702). Here, the management server 103 further retrieves products having the same category.

Then, the management server 103 sorts out the unit 1404 from the database (S1703). Here, the management server 103 further retrieves products having the same unit.

Then, the management server 103 sorts out the detailed data 1405 from the database (S1704). Here, the management server 103 further retrieves products in accordance with the detailed data in the difference amount vicinity. Note that a product may not be detected at this time.

In this modified example, a product is retrieved in accordance with the mother product 1402, the category 1403, the unit 1404, and the detailed data 1405. However, similarly to this embodiment, this sorting condition may be set by the user.

### SECOND MODIFIED EXAMPLE

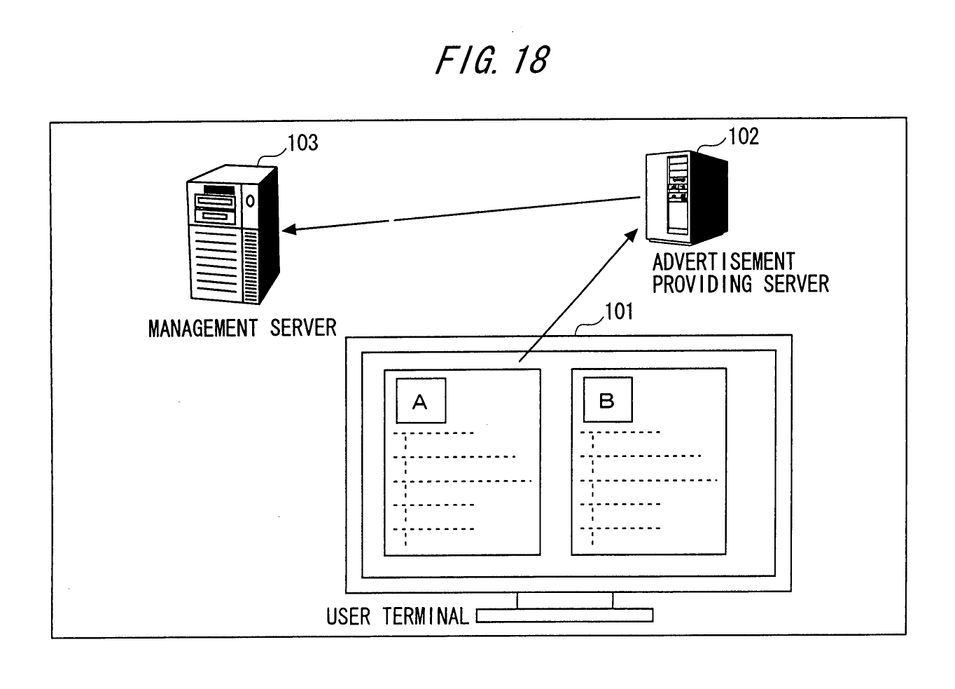

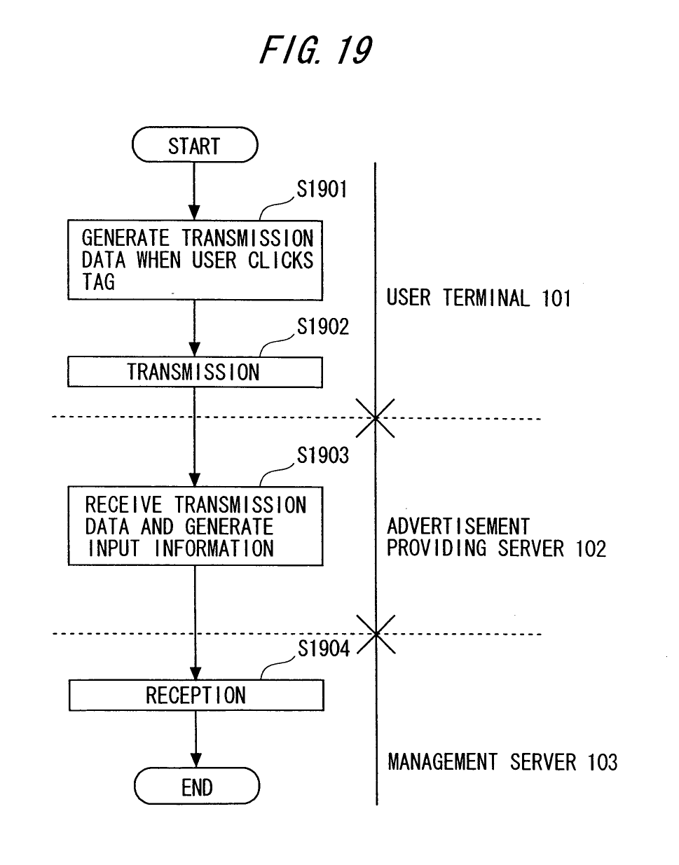

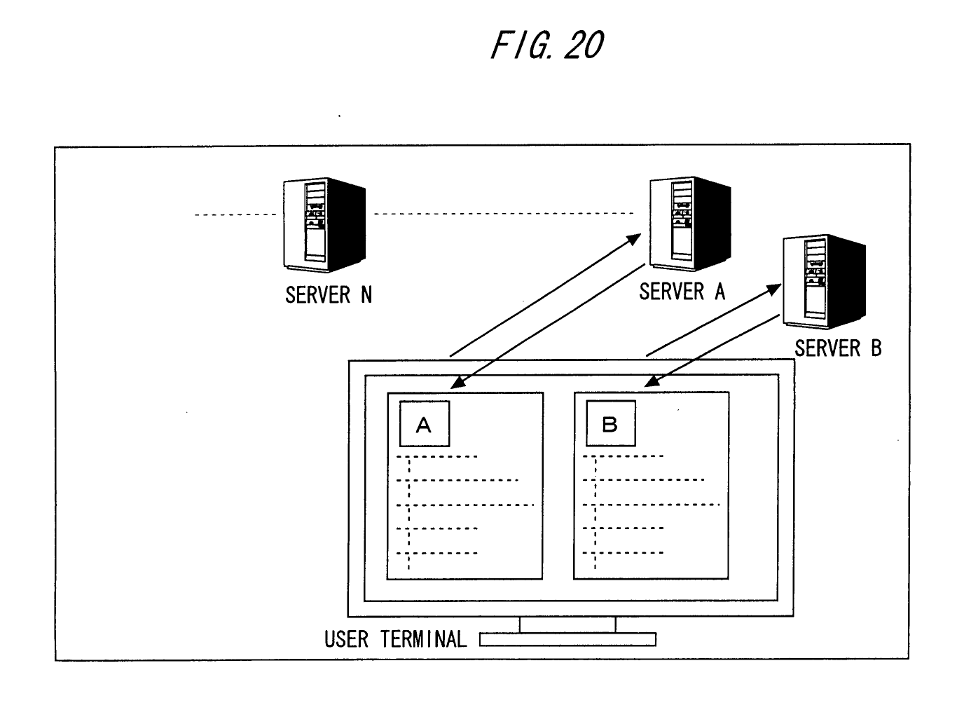

With reference to FIGS. 18 and 19, a second modified example will be explained.

<System Configuration>

With reference to FIG. 18, a system configuration of the second modified example will be explained. This system includes the user terminal 101, the plurality of advertisement providing servers 102, and the management server 103, which are connected through the network such as the Internet and the like, similarly to the system shown in FIG. 1.

In the above-described embodiment, the input information is directly transmitted to the management server 103 from the user terminal 101. However, in the second modified example, the user terminal 101 transmits transmission data to the advertisement providing server 102. Then, the advertisement providing server 102 generates the input information in accordance with the transmission data. After that, the input information is transmitted to the management server 103 from the advertisement providing server 102.

<Input Information Transmission Route>

With reference to FIG. 19, a transmission algorithm of input information transmitted from the user terminal 101 will be explained.

The user terminal 101 generates transmission data upon clicking the representation defined by the tag within the content by the user (S1901). The transmission data can be generated by using a programming language such as JAVA (Registered Trademark). Then, the user terminal 101 transmits the generated transmission data to the advertisement providing server 102 (S1902).

Then, the advertisement providing server 102 receives the transmission data generated by the user terminal 101, and generates the input information (S1903). Here, the transmission data is necessary to generate the input information. For example, when the advertisement providing server 102 gives unique identifiers to the specifications and price of the product, the advertisement providing server 102 can generate the input information based on the identifiers. Thus, in this case, the transmission data includes the identifiers.

Then, the advertisement providing server 102 transmits the generated input information to the management server 103. After that, the management server 103 receives the input information generated by the advertisement providing server 102 (S1904).

The modified example has the following effects.

When the transmission data is the identifiers with regard to the specifications and price of the product, the transmission data is simple, and its data amount is also small. Thus, the time required to generate the transmission data is shorter than the time required to generate the input information.

Also, when the advertisement providing server 102 is a high performance server used in a company or the like, the time required to generate and transmit the input information is shorter than the time required when it is generated and transmitted by the user terminal 101.

Also, since the input information selected by the user is transmitted via the advertisement providing server 102, the advertisement provider can grasp the user trend.

<Computer-readable Storage Medium>

A program for causing a computer to execute any of the processes in the above-described embodiment can be recorded in a computer-readable storage medium. Then, the program recorded in the storage medium is read into the computer to be executed. Consequently, the system described in this embodiment can be provided.

Here, the computer-readable storage medium implies a storage medium where information of data, programs, and the like can be accumulated by an electric, magnetic, optical, mechanic, or chemical action and can be read from a computer. Among the storage media, the storage media that can be removed from the computer include a flexible disk, a magneto-optical disk, a CD-ROM, a CD-R/W, a DVD, a DAT, an 8-mm tape, and a memory card.

In addition, the recording media fixed to the computer include a hard disk, and a ROM (Read Only Memory).

Note that this embodiment does not limit the range of the present invention. Various modifications are properly possible within the range that can be understood by those skilled in the art.

### INDUSTRIAL APPLICABILITY

The present invention can be used in the technical field where the advertising and promotion activities are conducted through the Internet.

What is claimed is:

1. An information providing method, comprising the steps of:
detecting a predetermined operation on a first information displayed on a client terminal;
detecting a predetermined operation on a second information displayed on the client terminal;
generating comparative information by comparing the first information with the second information; and
providing the comparative information to the client terminal.

2. The information providing method according to claim 1, wherein when the second information is judged to be in a predetermined relation with the first information, the first information and the second information are compared with each other in the step of generating the comparative information.

3. The information providing method according to claim 1, wherein when the first information and the second information indicate prices or performances related to products, the comparative information indicates a difference between the prices or the performances of the products.

4. The information providing method according to claim 3, further comprising the steps of:
generating a related product information corresponding to the difference between the prices or the performances; and
providing the related product information to the client terminal.

5. The information providing method according to claim 1, wherein the predetermined operation is a clicking operation through a pointing device with respect to the first information or the second information.

6. The information providing method according to claim 1, wherein the predetermined operation includes: an input of an input information including the first information and the second information; and a transmission request of the input information.

7. A recording medium, which stores a program for causing a computer to execute the steps of:
detecting a predetermined operation on a first information displayed on a client terminal;
detecting a predetermined operation on a second information displayed on the client terminal;
generating comparative information by comparing the first information with the second information; and
providing the comparative information to the client terminal.

8. The recording medium according to claim 7, wherein when the second information is judged to be in a predetermined relation with the first information, the first information and second information are compared with each other in the step of generating the comparative information.

9. The recording medium according to claim 7, wherein when the first information and the second information indicate prices or performances related to products, the comparative information indicates a difference between the prices or the performances of the products.

10. The recording medium according to claim 9, which stores a program for causing a computer to further execute the steps of:
generating a related product information corresponding to the difference between the prices or performances; and
providing the related product information to the client terminal.

11. The recording medium according to claim 7, wherein the predetermined operation is a clicking operation through a pointing device with respect to the first information or second information.

12. The recording medium according to claim 7, wherein the predetermined operation includes: an input of input information including the first information and the second information; and a transmission request of the input information.

13. An information providing apparatus, comprising:
a unit detecting a predetermined operation on a first information displayed on a communication apparatus;
a unit detecting a predetermined operation on a second information displayed on the communication apparatus;
a unit generating comparative information by comparing the first information with the second information; and
a unit providing the comparative information to the communication apparatus.

14. The information providing apparatus according to claim 13, wherein when the second information is judged to be in a predetermined relation with the first information, the unit for generating comparative information compares the first information with the second information.

15. The information providing apparatus according to claim 13, wherein when the first information and second information indicate prices or performances related to products, the comparative information indicates a difference between the prices or the performances of the products.

16. The information providing apparatus according to claim 15, further comprising:
a unit generating a related product information corresponding to the difference between the prices or performances; and
a unit providing the related product information to the communication apparatus.

17. The information providing apparatus according to claim 13, wherein the predetermined operation is a clicking operation through a pointing device with respect to the first information or second information.

18. The information providing apparatus according to claim 13, wherein the predetermined operation includes: an input of input information including the first information and the second information; and a transmission request of the input information.
